(19) United States
(12) Patent Application Publication
(10) Pub. No.: US 2024/0172041 A1
(43) Pub. Date: May 23, 2024

(54) A Method of Processing an Incoming Service Request by a First Network Function, NF, Instance, as well as the Corresponding Network Functions

(71) Applicant: Telefonaktiebolaget LM Ericsson (publ), Stockholm (SE)

(72) Inventors: Maria Cruz Bartolome Rodrigo, Madrid (ES); Chunbo Wang, Shanghai (CN)

(21) Appl. No.: 18/282,716

(22) PCT Filed: Feb. 22, 2022
(86) PCT No.: PCT/CN2022/077252

§ 371 Date: Sep. 18, 2023

(30) Foreign Application Priority Data
Mar. 22, 2021 (WO) PCT/CN2021/082103

(51) Int. Cl. H04W 28/02

(52) U.S. Cl. CPC H04W 28/0289

(57) ABSTRACT

A method of processing an incoming service request, by a Network Function, NF, service producer in a Service Based Architecture, SBA, based telecommunication network, wherein said NF service producer is arranged to provide services in corresponding service instances, said method comprising the steps of receiving, by said NF service producer, from an NF service consumer, a service request for a service provided by an NF service instance of said NF service producer, transmitting, by said NF service producer, to said NF service consumer, a congestion error indicating that there is an error upon detecting a congestion error with said NF service instance.

### TECHNICAL FIELD

The present disclosure is related to the processing of incoming service requests by a first Network Function, NF, instance and, more specifically, to processing these requests during congestion occurring at the first NF instance.

### BACKGROUND

The present disclosure is directed to Network Producers in a Service Based Architecture, SBA, based telecommunication networks. The Fifth Generation, 5G, telecommunication network is an example of an SBA based telecommunication network and is centered around services that can register themselves and subscribe to other services. This enables a more flexible development of new services, as it becomes possible to connect to other components without introducing specific new interfaces.

Currently, scenarios exist in which an Network Function, NF, producer in such an SBA based telecommunication network fails to process an incoming service request and responds with an HTTP 503 or 429 Internal Server Error and, in addition it may determine that there is a so-called congestion or congestion risk, respectively.

A congestion risk is currently directed to a scenario in which too many requests are being received by a corresponding NF producer, such that a particular request is rejected due to excessive traffic which, if continued over time, may lead to, or may increase, an overload situation at the NF producer.

The congestion is currently directed to a scenario in which the service is unavailable as the NF producer experiences congestion and performed overload control, which does not allow a particular request to be processed.

A particular NF consumer that requests the service may then be confronted, by the corresponding NF producer, that the service cannot be provided due to one of congestion itself or a risk to congestion.

The above would lead the NF consumer to take into account that the service producer is currently unavailable. Any further request for a particular service is then to be directed to another service producer to make sure that the traffic towards the congested NF producer is abated.

One of the drawbacks of the scenarios described above is that this may not be the most efficient way in dealing with congestion situations at an NF producer.

### SUMMARY

The inventors have found a more advantageous way of dealing with congestion situation at an NF producer, which is explained in more detail later below. As such, it would be advantageous to obtain methods and devices arranged in such a way that they deal with congestion situations in a more efficient manner.

In a first aspect of the present disclosure, there is provided a method of processing an incoming service request, by a first Network Function, NF, instance providing services in corresponding NF service instances, in a Service Based Architecture, SBA, based telecommunication network, said method comprising the steps of:
receiving, by said first NF instance, a service request for a service provided by an NF service instance of said first NF instance;
transmitting, by said first NF instance, in reply to said service request, a congestion error indicating that there is an error upon detecting a congestion error with said NF service instance of said first NF instance.

In accordance with the present disclosure, an NF service instance is an environment that makes the functionality of a particular service available. Several of such environments may exist that deliver essentially the same functionality, but for different purposes and/or to different users.

An NF service may be expected to be self-contained, reusable and use management schemes independently of other NF services offered by the same Network Function and/or Network Function instance, for example for scaling, healing, etc.

A particular service provided by the Network Function service producer may simultaneously be requested by a plurality of different Network Function service consumers, i.e. a plurality of Network Function (service) instances. The Network Function service producer may then instantiate a plurality of Network Function service instances, wherein each instance creates the environment for providing the service to one of the Network Function service consumers.

As mentioned in the background section, in the prior art it is assumed that either there is a congestion for the Network Function producer as a whole, or there is a congestion risk for the Network Function producer in case a particular request is allowed.

In accordance with the present disclosure, it is noted that the Network Function producer may be referred to as the first Network Function, NF, instance. The Network Function consumer may be referred to as the second Network Function, NF, instance.

The Network Function service instance that is arranged to provide the service may also be called the server and the Network Function that is arranged to consume, or receive, the service may also be called the client.

The inventors have found that, in both cases, the Congestion or Congestion Risk may be identified for the whole NF producer, i.e. the whole NF instance, or just for the requested service, i.e. a corresponding NF service instance. This may depend on the internal software architecture and congestion characteristics, i.e. it may affect only the resources required to execute the requested NF service instance, or may affect resources required for the NF producer, i.e. the NF instance itself, and it may be useful to identify the specific situation to proceed to corresponding mitigation actions in the NF service consumer, based on the received error indication.

It was further found that the error message in the prior art relates to NF service producer congestions such that there is no possibility to indicate, by the NF service producer, i.e. by the NF instance, that there is only a congestion in relation to a particular service provided by the NF service producer, i.e. a congestion in the corresponding NF service instance. That means that, in the prior art, whenever such an error message is received, the NF service consumer needs to consider it applies for the whole NF service producer, i.e. the whole NF service producer instance, i.e. the whole NF instance, what will unavoidably lead to penalties to other services provided by that NF service producer that are not congested.

Following the above, the congestion error indicates that there is an error upon detecting a congestion error with said NF service instance. This does not mean that the congestion error is related to the whole NF producer instance.

The congestion error is thus bound to a particular service of an NF service producer, and the received congestion error does not imply, explicitly or implicitly, that the corresponding NF service producer, i.e. the NF instance is congested somehow. These concepts are, in accordance with the present disclosure separated.

In an example, the method comprises the step of determining, by said first NF instance, that there is a congestion error for said NF service instance of said first NF instance.

The NF service producer, i.e. the NF instance, may, for example, determine that there are no resources available for instantiating an NF service instance for the requested service. This is a type of error that is bound to a specific service. Resources may, for example, still be available for other service instances, i.e. other services, that are to be provided by the NF service producer but not for the specific service that is requested by the NF service consumer.

In a further example, the step of determining further comprises:
determining, by said first NF instance, that there is said congestion error for said NF service instance of said first NF instance based on at least one of:
a congestion of said NF service instance for said requested service;
a risk to congestion of said NF service instance for said requested service.

The above may thus also entail that the NF service producer determines that there are no resources available for the NF service instance, or that there is a risk that there no resource will be available for the NF service instance corresponding to the service.

In a further example, the congestion error is comprised by any of:
message indicating that the service request is rejected due to excessive traffic which may lead to an overload situation of said NF service instance, i.e. having the HTTP status code “Too Many Requests”;
message indicating that said NF service instance experiences congestion, i.e. having the HTTP status code “Service Unavailable”.

The error messages may be communicated using Hypertext Transfer Protocol, HTTP, status codes, wherein, for example, the Too Many requests message is conveyed using a HTTP 429 status code and the Service Unavailable message is conveyed using a HTTP 503 status code.

The HTTP 429 Too Many Requests response status code may indicate that the NF service consumer, i.e. an NF node, has sent too many requests, or that the NF service producer, i.e. the receiving NF node, has received too many request, in a given amount of time. The given amount of time may be variable, pre-determined, or depending on resource availability or anything alike. A Retry-After header might be included in this response indicating how long the NF service consumer should wait before making a new request for this particular service.

The HTTP 503 Service Unavailable server error response code indicates that the Network Function service producer, i.e. the NF instance and/or the corresponding NF service instance, is not ready to handle the request for this particular service. Common causes are a Network Function service producer that is down for maintenance or that is overloaded for the particular service. This response may be used for temporary conditions and the Retry-After HTTP header should, if possible, contain the estimated time for the recovery of the service.

In a further example, the method further comprises the steps of:
receiving, by said first NF instance a further service request for a different service provided by a different NF service instance of said first NF instance, wherein said congestion error has been detected with said NF service instance;
providing, by said first NF instance said requested different service via said different NF service instance.

The above described example provides a scenario in which the particular NF service producer, i.e. the first NF instance, is providing a particular “different” service, using a particular NF service instance, to the same NF service consumer although initially it was indicated that a congestion occurred for the initially requested service. This, thus, provides for a scenario in which both situations are occurring simultaneously.

In a second aspect of the present disclosure, there is provided a method of requesting, by a second NF instance, i.e. NF service consumer, in an Service Based Architecture, SBA, based telecommunication network, a service from a Network Function, service producer, i.e. a first NF instance, in said SBA based telecommunication network, wherein said first NF instance is arranged to provide services in corresponding NF service instances. The method comprises the steps of:
transmitting, by said second NF instance, to said first NF instance, a service request for a service provided by an NF service instance of said first NF instance;
receiving, by said second NF instance, from said first NF instance, a congestion error indicating that there is a congestion error with said NF service instance providing said requested service.

It is noted that the advantages as explained with respect to the first aspect of the present disclosure, being the method of processing an incoming service request, are also applicable to the second aspect of the present disclosure, being the method of requesting a particular service from an NF service producer, i.e. from a first NF instance.

The NF service consumer may thus receive a congestion error indicating that there is a congestion error with the NF service instance providing the requested service.

This may invoke that the NF service consumer holds any subsequent requests for the same service to the NF service producer for, for example, a particular time or until the NF service consumer is notified that the congestion for that particular service is lifted.

The NF service consumer may, for example, wait for a predetermined time before trying the particular service again at the same NF service producer, or may wait an amount of time which is indicated by the NF service producer itself before trying again. An exponential back-off timer may also be applied for assuring that congestion is not re-occurring at every retry.

The above may also entail that the same NF service producer may still be approached for other services, as the specific error message is only directed to one particular service. For other services, there might not be a congestion situation at the NF service producer, such that for these other services the NF service producer may still be approached.

In a further example, the congestion error indicates any of:
a congestion of said NF service instance for said requested service;
a risk to congestion of said NF service instance for said requested service.

The above may thus entail that the congestion error indicates that the resource corresponding to the NF service instance for the requested service are currently unavailable or that the there is a risk that the resources for the NF service instance for the requested service will become unavailable.

In a further example, the congestion error is any of:
a Too Many Requests message indicating that the service request is rejected due to excessive traffic which may lead to an overload situation of said NF service instance;
a Service Unavailable message indicating that said NF service instance experiences congestion.

In another example, the method further comprises the steps of:
transmitting, by said second NF instance, a further service request for a different service provided by a different NF service instance of said first NF instance, wherein said congestion error has been detected for said NF service instance;
consuming, by said second NF instance, from said first NF instance, said requested different service via said different NF service instance.

In a third aspect of the present disclosure, there is provided a first Network Function, NF, instance arranged for operating in a Service Based Architecture, SBA, based telecommunication network, arranged for processing an incoming service request, wherein said first NF instance is arranged to provide services in corresponding NF service instances, said first NF instance comprises:
receive equipment arranged for receiving a service request for a service provided by an NF service instance of said first NF instance;
transmit equipment arranged for transmitting, in reply to said received service request, a congestion error indicating that there is an error upon detecting a congestion error with said NF service instance.

It is noted that the advantages as explained with respect to the first aspect of the present disclosure, being the method of processing an incoming service request, and to the second aspect of the present disclosure, being the method of requesting a particular service from an NF service producer, are also applicable to the third aspect of the present disclosure, being the NF service producer.

In accordance with the present disclosure, equipment may be interchanged with organ, module, device or anything alike.

In an example, first NF instance further i.e. the NF producer, comprises:
process equipment arranged for determining that there is a congestion error for said NF service instance of said first NF instance.

In a further example, process equipment is further arranged for determining that there is said congestion error for said NF service instance of said NF service producer based on at least one of:
a congestion of said NF service instance for said requested service;
a risk to congestion of said NF service instance for said requested service.

In yet another example, the congestion error is any of:
a Too Many Requests message indicating that the service request is rejected due to excessive traffic which may lead to an overload situation of said NF service instance;
a Service Unavailable message indicating that said NF service instance experiences congestion.

In an example, said receive equipment is further arranged for receiving a further service request for a different service provided by a different NF service instance of said first NF instance, wherein said congestion error has been detected for said first NF service instance;
said transmit equipment is further arranged for providing, in response to said received further service request, said requested different service via said different NF service instance.

In a fourth aspect of the present disclosure, there is provided a second Network Function, NF, instance arranged for operating in a Service Based Architecture, SBA, based telecommunication network, and arranged for requesting a service from a first NF instance in said SBA based telecommunication network, wherein said second NF instance is arranged to provide services in corresponding first NF service instances, wherein said second NF instance comprises:
transmit equipment arranged for transmitting a service request for a service provided by an NF service instance of said first NF instance;
receive equipment arranged for receiving, by said second NF instance, from said first NF instance, a congestion error indicating that there is a congestion error with said NF service instance providing said requested service.

It is noted that the advantages as explained with respect to the first aspect, the second aspect and the third aspect are also applicable to the fourth aspect of the present disclosure, being the NF service consumer, i.e. the second NF instance.

In an example, the congestion error indicates any of:
a congestion of said NF service instance for said requested service;
a risk to congestion of said NF service instance for said requested service.

In a further example, the congestion error is any of:
a Too Many Requests message indicating that the service request is rejected due to excessive traffic which may lead to an overload situation of said NF service instance;
a Service Unavailable message indicating that said NF service instance experiences congestion.

In an even further example, the transmit equipment is further arranged for transmitting a further service request for a different service provided by a different NF service instance of said NF service producer, wherein said congestion error with said NF service instance is detected and said receive equipment is further arranged for receiving, from said NF service producer, said requested different service via said different NF service instance.

It is noted that aspects described with respect to one example may be incorporated in different examples although not specifically described relative thereto. That is, all examples and/or features of any examples can be combined in any way and/or combination. Moreover, other Network Functions and corresponding methods and computer program products according to examples will be or become apparent to one with skill in the art upon review of the following drawings and detailed description.

### BRIEF DESCRIPTION OF THE DRAWINGS

FIG. 1 discloses an example flow chart in which congestion is managed at Network Function, NF, level;

FIG. 2 discloses an example flow chart in which congestion is managed at service level;

FIG. 3 discloses an example of a Network Function, NF, service producer in accordance with the present disclosure;

FIG. 4 discloses an example of a Network Function, NF, service consumer in accordance with the present disclosure.

### DETAILED DESCRIPTION

Exemplifying embodiments will now be described more fully with reference to the appended drawings, in which currently preferred examples according to the present disclosure are shown. The examples should not be construed as limiting to embodiments of the present invention.

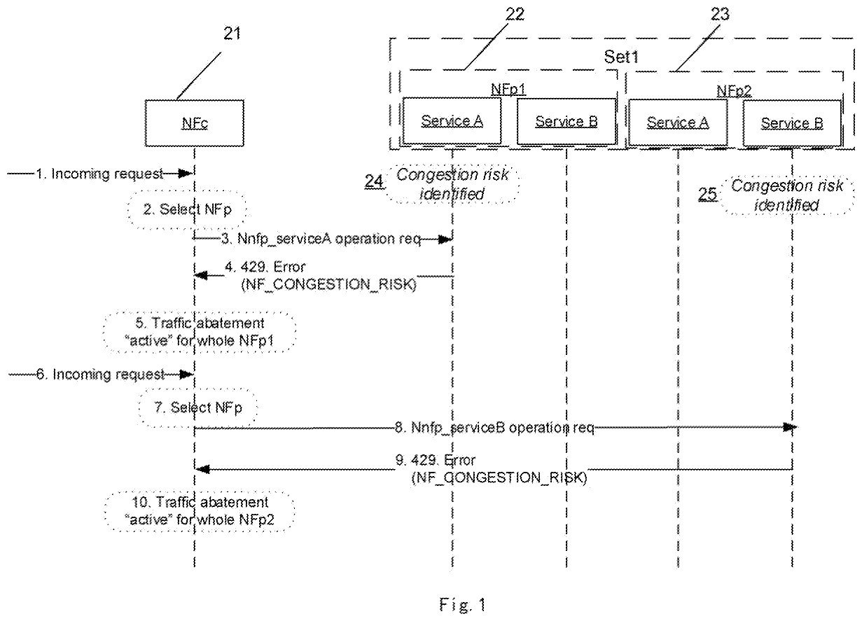

FIG. 1 discloses an example flow chart in which congestion is managed at Network Function, NF, level.

The method in accordance with the present disclosure is to be performed in a Service Based Architecture, SBA, based telecommunication network. A 5G telecommunication network is an example of such an SBA based telecommunication network. The 5G core network may comprise a plurality of Network Functions, NFs, that may operate as an NF service producer as well as an NF service consumer. A NF (node) may instantiate an NF instance. Different NF types exist, a couple of which are highlighted here below.

An Access and Mobility Management Function, AMF, is arranged to manage access control and mobility. The AMF may include the Network Slice Selection Function, NSSF.

A Session Management Function, SMF, is a function which is arranged to set up and manage sessions, according to network policy.

The User Plane Function, UPF, may be deployed in various configurations and locations, according to the service type. These are considered equivalent of Gateways in a 4G telecommunication network.

The Policy Control Function, PCF, is arranged to provide a policy framework incorporating network slicing, roaming and mobility management and is considered equivalent to a Policy and Charging Rules Function, PCRF in a 4G telecommunication network.

FIG. 1 discloses a situation in which a Network Function, NF, service consumer 21, i.e. a second NF instance, intends to use a service provided by a NF service producer 22, 23, i.e. a first NF instance. In this particular case, the NF service consumer 21 intends to use a service called “A”.

In a first step, the NF service consumer 21 may receive an incoming request from another node or, alternatively, an internal event, that requires that the NF service consumer 21 executes the service “A”. This is indicated with reference numeral 1.

The NF service consumer will then select 2 a NF service producer 22 based on, for example, availability. In this particular case, the NF service producer having reference numeral 22 is selected to process the particular request, for example based on Locality, priority, even Load/Capacity, or anything else.

A service request is then transmitted 3 by the NF service consumer 21 to the selected NF service producer 22. In this particular case, the NF service producer 22 may have identified a congestion risk 14 and will thus sent an error back to the NF service consumer 4 that a congestion risk is detected.

In step 5, based on the received error, as per application error as defined in the corresponding standard, the NF service consumer will need to mitigate the indicated congestion risk. Overload control may, for example, be based on HTTP status codes what means that part of the traffic toward the NF service producer that signalled the error may be abated for example either by redirecting or throttling.

In step 6 another request is incoming from another NF, or again an internal event that may require the NF service consumer to execute a service called “B”.

In step 7, the NF service consumer, again, selects a NF service producer 23 that will be the responsible NF service producer 23 for providing the service. In this particular case, the NF service consumer 21 selects the NF service producer having reference numeral 23. In doing so, the NF service consumer 21 takes into account that a congestion risk was signalled with respect to the NF service producer 22 so that NF service producer 22 was not selected by this particular NF service consumer 21 for this particular service “B”.

In steps 8 and 9, the NF service consumer 21 sends a service “B” operation request to the NF service producer 23. In this particular case, it may happen that NF service producer 23 has also identified a congestion risk 15, and will thus respond to the NF service consumer 21 with an error message.

In step 10, the NF service consumer 21 will need to mitigate traffic towards both the NF service producer having reference numeral 22 as well as the NF service producer having reference numeral 23. This ends up in some traffic rejected/throttle while, in fact, there are available resources.

The inventors have found that in for example the scenario shown in FIG. 1, the service “B” may still be provided by the NF service producer having reference numeral 22 and the service “A” may still be provided by the NF service producer having reference numeral 23. In the prior art scenario, such capacity/efficiency is lost.

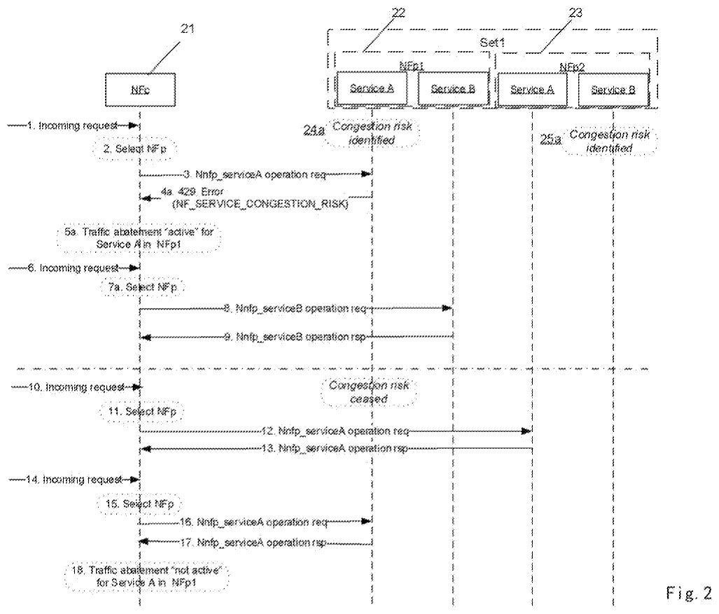

FIG. 2 discloses an example flow chart in which congestion is managed at service level.

In accordance with the present disclosure, the NF service producer is able to signal a Congestion or Congestion Risk per NF service, which allows the NF service consumer to apply, if desired, the correct Congestion abatement, i.e. either for the requests directed to any service for the NF, or just the service for the one the Congestion was signalled. This is explained in more detail with respect to FIG. 2.

The same reference numerals are used in FIG. 2 compared to the ones in FIG. 1 for improving the readability.

The congestion risk that is identified 24a is a risk to a congestion for a particular service “A”, i.e. for instantiating a particular service instance corresponding to a particular service.

This means that in step 4a, the error related to the congestion risk for that particular service “A”. The Network Function service consumer 21 is then aware that at least for the service “A” it should try to find another NF service producer that is able to provide for that service, for example the one as indicated with reference numeral 23. However, NF service consumer 21 may also be aware that for another service, for example service “B”, it may still approach the NF service producer 22 as the error message was only related to a congestion risk for the service “A”.

In step 5, based on the received error and the corresponding error message, the NF service consumer 21 may need to mitigate the indicated congestion risk for service “A” in NF service producer 22. As explained with reference to FIG. 1, this may mean that part of the traffic towards service “A” in NF service producer 22 is to be abated until the congestion risk is considered.

In step 6, again, an incoming request is received by the NF service consumer 21, wherein that request is directed to service “B”. Different to the scenario as shown in FIG. 1, the NF service consumer 21 selects the NF service producer having reference numeral 22 as the one that is to provide for service “B”. This is possible as the received error message in step 4a is related to a congestion risk related to service “A” only.

In step 10, an incoming request is received from another node, or an internal event, that requires that the NF service consumer 21 is to execute service “A”.

In step 21, traffic abatement is still active for Service A in NF service producer 22, such that part of traffic towards this particular instance needs to be reselected/diverted or throttled. In this case, NF service consumer 21 selects another available NF service producer service A instance, i.e. the one in NF service producer 23. The traffic abatement is still active in the consumer even though in this example it is indicated that the Congestion risk ceased before, but the NF service consumer may not have this information yet.

Steps 22, 23 show a successful request/response. The response is successful thanks to the congestion risk has ceased before.

Step 14. An incoming request from another node, or an internal event that requires that the NF service consumer 21 executes service A

Step 15. Traffic abatement is still active for Service A in NF service producer 22, as commented, part of traffic towards this instance needs to be reselected/diverted or throttled, but other part is still sent to the same target, like the one described in this step.

Steps 16,17. Successful request/response. The response is successful thanks to the congestion risk has ceased before.

Step 18. The NF service consumer 21 gets a successful response, then it has to consider the traffic abatement is ceased towards this destination. Note: In practice, the implementations take into account the rate of success messages vs error messages to consider whether the error situation is still active, it may not be based on one single success/error message.

This particular disclosure thus provides a mechanism to support indicating Congestion and Congestion Risk per service, that is, only affecting a single service in the NF service producer, rather that affecting the whole NF service producer.

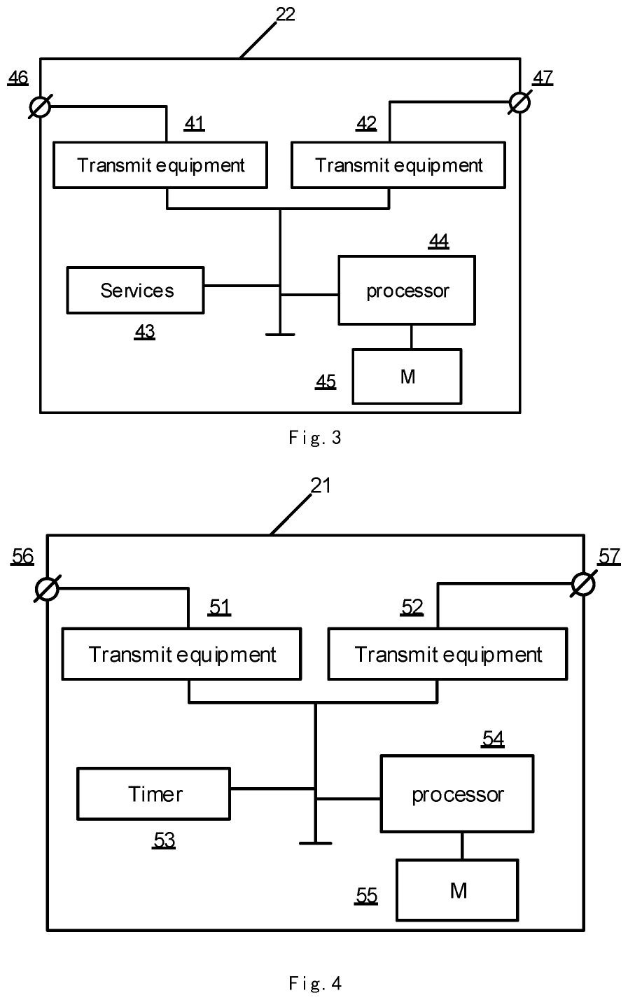

FIG. 3 discloses an example of a Network Function, NF, service producer in accordance with the present disclosure.

The Network Function, NF, service producer 22 is arranged for operating in a Service Based Architecture, SBA, based telecommunication network, arranged for processing an incoming service request, wherein said NF service producer is arranged to provide services in corresponding service instances, said NF service producer comprises:
receive equipment 41 arranged for receiving, from an NF service consumer, a service request for a service 43 provided by an NF service instance of said NF service producer;
transmit equipment 42 arranged for transmitting, to said NF service consumer, a congestion error indicating that there is an error upon detecting a congestion error with said NF service instance.

The NF service producer 22 may comprise a receiving terminal 46 and a transmit terminal 47 for receiving, and transmitting, corresponding packets or messages. The NF service producer 22 may further comprise a processor 44 and a memory 45.

FIG. 4 discloses an example of a Network Function, NF, service consumer in accordance with the present disclosure.

The Network Function, NF, service consumer 21 is arranged for operating in a Service Based Architecture, SBA, based telecommunication network, and arranged for requesting a service from an NF service producer in said SBA based telecommunication network, wherein said NF service producer is arranged to provide services in corresponding service instances, wherein said NF service consumer comprises:
transmit equipment 52 arranged for transmitting, to said NF service producer, a service request for a service provided by an NF service instance of said NF service producer;
receive equipment 51 arranged for receiving, by said NF service consumer, from said NF service producer, a congestion error indicating that there is a congestion error with said NF service instance providing said requested service

The NF service consumer 21 may comprise a receiving terminal 56 and a transmit terminal 57 for receiving, and transmitting, corresponding packets or messages. The NF service producer 21 may further comprise a processor 54 and a memory 55.

Following the above, the received error, by the NF service consumer, may be directed to a service congestion risk and an actual service congestion.

The actual service congestion may indicate that the corresponding NF service instance experiences congestion and performs overload control, which does not allow the request to be processed.

The service congestion risk may indicate that the request is rejected due to excessive traffic which, if continued over time, may lead to, or may increase, an overload situation of the corresponding NF service instance.

Many variations and modifications can be made to the examples provided above without substantially departing from the principles of the present inventive concepts. All such variations and modifications are intended to be included herein within the scope of present inventive concepts. Accordingly, the above disclosed subject matter is to be considered illustrative, and not restrictive, and the examples are intended to cover all such modifications, enhancements, and other embodiments, which fall within the spirit and scope of present inventive concepts.

1-19. (canceled)

20. A method of processing an incoming service request, by a first Network Function (NF) instance providing services in corresponding NF service instances, in a Service Based Architecture (SBA) based telecommunication network, said method comprising:
receiving, by said first NF instance, a service request for a service provided by an NF service instance of said first NF instance;
transmitting, by said first NF instance, in reply to said service request, a congestion error indicating that there is an error upon detecting a congestion error with said NF service instance of said first NF instance.

21. The method of claim 20, wherein said method further comprises:
determining, by said first NF instance, that there is a congestion error for said NF service instance of said first NF instance.

22. The method of claim 21, wherein said determining further comprises:
determining, by said first NF instance, that there is said congestion error for said NF service instance of said first NF instance based on at least one of:
a congestion of said NF service instance for said requested service;
a risk to congestion of said NF service instance for said requested service.

23. The method of claim 20, wherein said congestion error is comprised by any of:
a message indicating that the service request is rejected due to excessive traffic which may lead to an overload situation of said NF service instance;
a message indicating that said NF service instance experiences congestion.

24. The method of claim 20, wherein said method further comprises:
receiving, by said first NF instance, a further service request for a different service provided by a different NF service instance of said first NF instance, wherein said congestion error has been detected for said NF service instance;
providing, by said first NF instance, in reply to said further service request, said requested different service via said different NF service instance.

25. A method of requesting, by a second Network Function (NF) instance in a Service Based Architecture (SBA) based telecommunication network, a service from a first NF instance which provides services in corresponding NF service instances in said SBA based telecommunication network, said method comprising:
transmitting, by said second NF instance, to said first NF instance, a service request for a service provided by an NF service instance of said first NF instance;
receiving, by said second NF instance, from said first NF instance, a congestion error indicating that there is a congestion error with said NF service instance providing said requested service.

26. The method of claim 25, wherein said congestion error indicates any of:
a congestion of said NF service instance for said requested service;
a risk to congestion of said NF service instance for said requested service.

27. The method of claim 25, wherein said congestion error is comprised by any of:
a message indicating that the service request is rejected due to excessive traffic which may lead to an overload situation of said NF service instance;
a message indicating that said NF service instance experiences congestion.

28. The method of claim 25, wherein said method further comprises the steps of:
transmitting, by said second NF instance, a further service request for a different service provided by a different NF service instance of said first NF instance, wherein said congestion error has been detected for said NF service instance;
consuming, by said second NF instance, from said first NF instance, said requested different service via said different NF service instance.

29. A first Network Function (NF) instance configured to operate in a Service Based Architecture (SBA) based telecommunication network and configured to process an incoming service request, wherein said first NF instance is configured to provide services in corresponding NF service instances, said first NF instance comprising:
receive circuitry configured to receive a service request for a service provided by an NF service instance of said first NF instance;
transmit circuitry configured to transmit, in reply to said received service request, a congestion error indicating that there is an error upon detecting a congestion error with said NF service instance.

30. The first NF instance of claim 29, wherein said NF instance further comprises:
processing circuitry configured to determine that there is a congestion error for said NF service instance of said first NF instance.

31. The first NF instance of claim 30, wherein said processing circuitry is further configured to determine that there is said congestion error for said NF service instance of said first NF instance based on at least one of:
a congestion of said NF service instance for said requested service;
a risk to congestion of said NF service instance for said requested service.

32. The first NF instance of claim 29, wherein said congestion error is comprised by any of:
a message indicating that the service request is rejected due to excessive traffic which may lead to an overload situation of said NF service instance;
a message indicating that said NF service instance experiences congestion.

33. The first NF instance of claim 29, wherein:
said receive circuitry is further configured to receive a further service request for a different service provided by a different NF service instance of said first NF instance, wherein said congestion error has been detected for said first NF service instance;
said transmit circuitry is further configured to provide, in response to said received further service request, said requested different service via said different NF service instance.

34. A second Network Function (NF) instance configured to operate in a Service Based Architecture (SBA) based telecommunication network, and configured to request a service from a first NF instance in said SBA based telecommunication network, wherein said second NF instance is configured to provide services in corresponding first NF service instances, wherein said second NF instance comprises:
transmit circuitry configured to transmit a service request for a service provided by an NF service instance of said first NF instance;
receive circuitry configured to receive, by said second NF instance, from said first NF instance, a congestion error indicating that there is a congestion error with said NF service instance providing said requested service.

35. The second NF instance of claim 34, wherein said congestion error indicates any of:
a congestion of said NF service instance for said requested service;
a risk to congestion of said NF service instance for said requested service.

36. The second NF instance of claim 34, wherein said congestion error is comprised by any of:
a message indicating that the service request is rejected due to excessive traffic which may lead to an overload situation of said NF service instance;
a message indicating that said NF service instance experiences congestion.

37. The second NF instance of claim 34, wherein:
said transmit circuitry is further configured to transmit a further service request for a different service provided by a different NF service instance of said first NF instance, wherein said congestion error with said NF service instance is detected;
said receive circuitry is further configure to receive, from said first NF instance, said requested different service via said different NF service instance.

38. A non-transitory computer-readable medium having instructions stored thereon which, when executed by a Network Function (NF) in a Service Based Architecture (SBA) based telecommunication network, cause said NF to implement the method of claim 20.
